(19) United States
(12) Patent Application Publication
(10) Pub. No.: US 2008/0023639 A1
(43) Pub. Date: Jan. 31, 2008

(54) Ultraviolet Irradiation Apparatus

(75) Inventors: Kimihiko Kawasaki, Tokyo (JP); Kenji Kobayashi, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: LINTEC CORPORATION, Tokyo (JP)

(21) Appl. No.: 11/632,652

(22) PCT Filed: Jul. 20, 2005
(86) PCT No.: PCT/JP05/13267

§ 371 Date: Jan. 16, 2007

(30) Foreign Application Priority Data
Jul. 22, 2004 (JP) 2004-214534

(51) Int. Cl. G21K 5/10

(52) U.S. Cl. 250/372; 250/492.2

(57) ABSTRACT

A semiconductor wafer is taken as an object to be irradiated, to which a protection sheet S is stuck via an ultraviolet cured adhesive layer, and an ultraviolet irradiation part 12 is disposed facing the protection sheet S, the ultraviolet irradiation part 12 being provided with a plurality of the ultraviolet light-emitting diodes 21 disposed on the substrate 20. The light-emitting diodes 21 are arranged to be spaced equally from each other on the straight lines L1 of plural rows substantially perpendicular to a relative movement direction to the wafer, and between the neighboring light-emitting diodes in each row, a part of the light-emitting diode of the neighboring row is positioned.

### TECHNICAL FIELD

The present invention relates to an ultraviolet irradiation apparatus and in particular, to an ultraviolet irradiation apparatus using a light-emitting diode.

### BACKGROUND ART

In processing apparatus of semiconductor wafer (simply referred to as “wafer” hereinafter), for example, predetermined processes are carried out in a state where a protection tape is stuck on a circuit surface of the wafer. This protection tape adopts an ultraviolet cured type resin for an adhesive layer, and an adhesive force thereof is weakened by curing the ultraviolet cured type resin with ultraviolet irradiation apparatus, thus enabling to peel off the protection tape easily.

There is known an apparatus as the ultraviolet irradiation apparatus arranged in such a way that, for example, a lamp case is disposed at a position facing the wafer face and in the lamp case, high-pressure mercurial lamps, metal halide lamps or the like are disposed (refer to Patent Document 1)

[Patent Document 1] Japanese Patent Application Laid-open No. 9-162141

### DISCLOSURE OF THE INVENTION

### Problems to be Solved by the Invention

However, the ultraviolet irradiation apparatus disclosed in Patent Document 1, has such an arrangement that high-pressure mercurial lamps are adopted as light-emitting source, which requires a high-voltage transformer. As a result, the apparatus has such disadvantages that it is large in size and consuming a large amount of power as well. In addition to the fact that frequent maintenance work is required due to short life of lamps, so-called running-in time to comply with an ultraviolet irradiation condition is long, and thereby lamps are forcibly kept to be on within working hours, leading to a large amount of power consumption. Further, an efficient irradiation control can not be performed corresponding to a flat area of an object to be irradiated, and therefore, a waste of the power is unavoidable and also, since the lamp uses mercury, an environmental problem may be caused in the event of disposal.

Accordingly, the present inventor has attempted to develop an ultraviolet irradiation apparatus using an ultraviolet light-emitting diode as a light-emitting source of ultraviolet rays. For the apparatus in a research and development stage, as shown in FIGS. 10 and 11, such an arrangement was adopted that many light-emitting diodes 51 were disposed to be spaced equally from each other along a substantially lattice-shaped trace on a substrate 50, on the other hand a protection sheet S provided with an adhesive layer 53 made of an ultraviolet irradiation cured type resin was disposed on the surface of wafer W, facing the diodes 51, and both the protection sheet S and the diodes 51 had a relative movement in the direction of arrow B in FIG. 10, while ultraviolet rays were irradiated to the protection sheet S from the light-emitting diodes 51. It was found out that when the protection sheet S was peeled off after the ultraviolet irradiation, the region A where the curing of the adhesive layer 53 was not sufficiently performed appeared linearly along the direction perpendicular to a sheet plane of FIG. 11, which prevented the peeling of the protection sheet S.

It was found out that this was because, as shown in FIG. 11, the light-emitting diodes 51 were arranged to perform ultraviolet irradiation on the protection sheet S at a distance very close thereto and there were no light-emitting diodes 51 irradiating ultraviolet to the region A in a complementary manner due to the distance and the direction angle of the ultraviolet rays.

In this case, it is conceivable that a distance between the light-emitting diodes 51 and the protection sheet S is made to be sufficiently long. However, such a long distance causes ultraviolet attenuation, which raises another problem that the adhesive layer can not be cured as expected.

### Object of the Invention

The present invention has been proposed in view of the foregoing disadvantages and through recognition obtained in various experiments conducted for solving problems generated in use of the ultraviolet light-emitting diodes. The object of the present invention is to provide an ultraviolet irradiation apparatus, which can achieve remarkable downsizing, easy maintenance and inspection work, as well as workability of ultraviolet irradiation, and power saving.

### Means for Solving the Problems

In order to achieve the object, an ultraviolet irradiation apparatus of the present invention is arranged in such a manner that a plurality of ultraviolet light-emitting diodes are disposed at a position facing an object to be irradiated, and also the object and the light-emitting diodes are movable relatively with each other, wherein the light-emitting diodes are disposed to be equally spaced from each other on straight lines of a plurality of rows substantially perpendicular to the relative movement direction, and between neighboring light-emitting diodes in each row, a part of the light-emitting diode in the neighboring row is positioned.

The present invention may be preferably arranged in such a manner that the light-emitting diodes are provided to be detachable on the substrate.

The present invention may also be arranged in such a manner that several light-emitting diodes are unitized as one unit and each unit of the several light-emitting diodes is detachable on the substrate.

Further, the light-emitting diodes may be arranged in such a manner that the light-emitting regions thereof are controllable in accordance with a flat area of the object.

The present invention is preferably arranged in such a manner that illumination sensors are disposed on a table supporting the object with a predetermined span along a direction substantially perpendicular to the relative movement direction.

Further, the several light-emitting diodes may be unitized as one unit, and it may be arranged that irradiation performance of each unit or each light-emitting diode may be detected by value of current and/or voltage.

### Effects of the Invention

According to the present invention, the light-emitting diode is adopted as the light-emitting source for ultraviolet irradiation, which therefore, can eliminate such a large-scale device as a transformer in the conventional case of mercurial lamps adoption, thus enabling downsizing of the apparatus. And owing to adoption of such an arrangement that a part of each of the light-emitting diodes in a row is disposed between the neighboring light-emitting diodes in a different row, occurrence of non-irradiation regions that tends to be generated in use of the light-emitting diodes located close to the object can be avoided. The light-emitting diodes are detachable on the substrate, thereby replacement of only a part of the light-emitting diodes can contribute to easy maintenance work so that the cost for the maintenance work can be minimized. Further, the light-emitting regions can be controlled, whereby the consuming power is reduced and at the same time, a product life of the light-emitting diode can be assured over the long term. Still further, since the light-emitting diode does not require any running-in time in contrast to the high-pressure mercurial lamp, the light-emitting diode can switch on immediately before the start of irradiation, and the power source can be switched off when irradiation ends, so that a large amount of energy can be saved compared with the case of mercurial lamp, which requires to be kept on always. Providing the irradiation sensor allows the performance evaluation of the light-emitting diode securely, thereby avoiding insufficient ultraviolet irradiation. Besides, since failures of the light-emitting diode can be detected by controlling value of current and voltage of the light-emitting diode by means of an ammeter and/or a voltmeter, irradiation defects of the ultraviolet rays can be prevented.

### BRIEF DESCRIPTION OF THE DRAWINGS

FIG. 1 is a schematic view of an ultraviolet irradiation apparatus arrangement in a preferred embodiment;

FIG. 2 is a schematic plan view showing an arrangement example of light-emitting diodes;

FIG. 3 is a schematic front view showing ultraviolet irradiation regions;

FIG. 4 is a schematic plan view showing a state where initial light-emitting regions of the light-emitting diodes are controlled;

FIG. 5 is a schematic plan view showing a state where light is emitted from whole regions of the light-emitting diodes;

FIG. 6 is a schematic plan view showing a state where the light-emitting diodes are controlled in accordance with a flat area of an object to be irradiated;

FIG. 7 is a schematic front view showing an arrangement where the light-emitting diodes are detachable on the substrate;

FIG. 8 is a circuit arrangement view for measuring current in each unit defining a plurality of light-emitting diodes as one unit;

FIG. 9 is a circuit arrangement view for measuring voltage in each unit defining a plurality of light-emitting diodes as one unit;

FIG. 10 is a schematic front view in a case where the light-emitting diodes are arranged in parallel, longitudinally and laterally; and

FIG. 11 is a schematic front view for explaining problems due to the light-emitting diodes arrangement shown in FIG. 10.

### DESCRIPTION OF REFERENCE NUMERALS

10: ultraviolet irradiation apparatus

11: wafer support part

12: ultraviolet irradiation part

17: illumination sensor

21: light-emitting diode

w: semiconductor wafer (object to be irradiated)

### BEST MODE FOR CARRYING OUT THE INVENTION

Hereinafter, an embodiment of the present invention will be described with reference to the drawings.

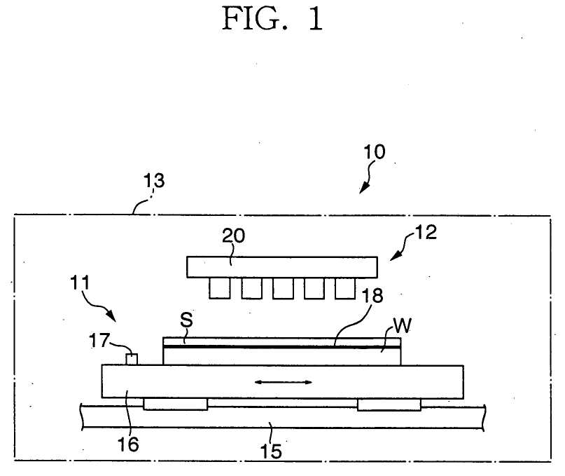

FIG. 1 is a schematic front view related to a preferred embodiment where an ultraviolet irradiation apparatus of the present invention is applied to a wafer processing apparatus. In the figure, the ultraviolet irradiation apparatus 10 is provided with a wafer support part 11 absorbing and supporting a wafer as an object to be irradiated, an ultraviolet irradiation part 12 disposed substantially in parallel with the wafer W above the wafer support part 11, and a chamber 13 surrounding the wafer support part 11 and the ultraviolet irradiation part 12.

The wafer support part 11 is provided with a guide 15 extending in the right and left directions in FIG. 1, a table 16 movable along the guide 15, the planar shape of the table 16 being formed substantially in square, and a plurality of illumination sensors 17 disposed with same intervals from each other along the direction perpendicular to a plane in FIG. 1. The table 16 is arranged in such a manner that an upper surface thereof is defined as an absorption face and a position of the wafer W is fixed as the wafer W being absorbed on the absorption face. A protection sheet S is stuck on an upper surface side (circuit face side) of the wafer W. An adhesive layer 18 of ultraviolet irradiation cured type is disposed on a lower surface side of the protection sheet S. The protection sheet Scan be peeled simply from the wafer W in a subsequent process through curing the adhesive layer 18.

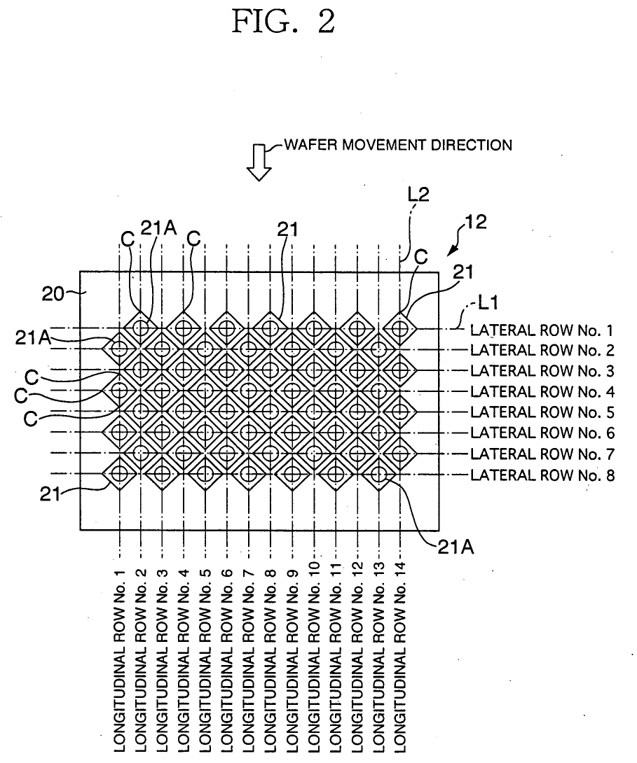

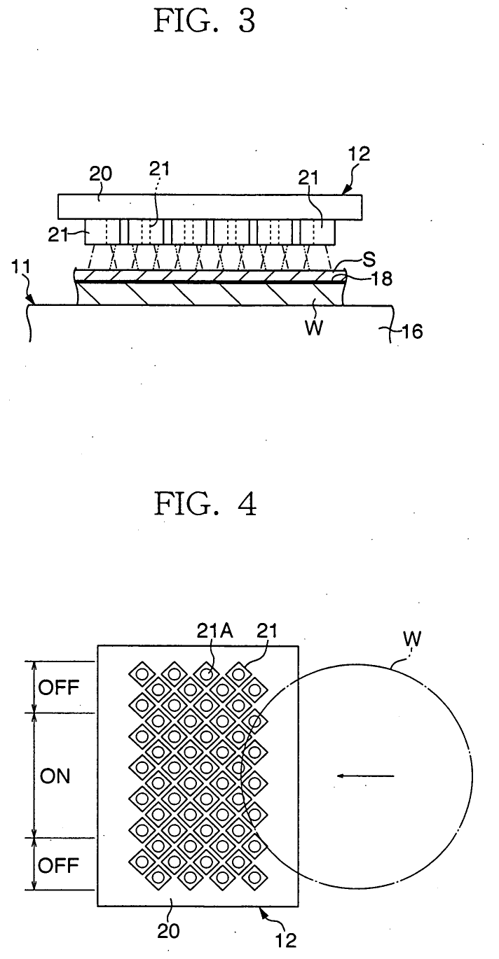

The ultraviolet irradiation part 12 is, as shown in FIG. 2, provided with a substrate 20, the planar shape of which is formed substantially in square, and many ultraviolet light-emitting irradiation diodes 21 disposed on a lower surface side of the substrate 20 in FIG. 1. The ultraviolet irradiation part 12 is arranged to be capable of relative movement to a surface of the wafer W within a planar face. The light-emitting diodes 21 are disposed to be equally spaced with each other on straight lines of a plurality of substantially parallel rows with each other along the relative movement directions (upper and lower directions in FIG. 2), and between the neighboring light-emitting diodes 21 in each row, a part of the light-emitting diode 21 of the adjacent row is positioned. More detailed description will be given below. That is, each light-emitting diode 21 is substantially square-shaped viewed in a plane and an ultraviolet light-emitting part 21A is positioned in the central portion. The light-emitting diodes 21 are disposed in such a manner that corners C of the light-emitting diodes are positioned on the first lines L1 corresponding to lateral rows from row No. 1 to row No. 8 extending along the direction substantially perpendicular to the relative movement directions and on the second lines L2 corresponding to longitudinal rows from row No. 1 to row No. 14 extending along the direction substantially perpendicular to the first lines L1 on the same plane(wafer movement direction). Intervals between each of the first lines L1 are set substantially equal and intervals between each of the second lines L2 are set substantially equal as well. In an example in FIG. 2, for example, between the light-emitting diodes 21 in the lateral row No. 1, a part or an upper half portion of the light-emitting diode in the lateral row No. 2 is positioned and in the same manner hereafter, an upper half-portion of each of the light-emitting diodes in the lateral row No. 3 is positioned between the neighboring light-emitting diodes in the lateral row No. 2. The correlation of diode disposition above described is the same in the case of longitudinal rows. Note that the number of longitudinal and lateral rows in FIG. 2 is shown for convenience' sake, and the number of these rows increases or decreases if needed.

In the above arrangement, when the relative movement direction between the wafer support part 11 and the ultraviolet irradiation part 12 coincides either one of the lines L1 or L2, or is in a close condition therewith, it is possible to eliminate the non-irradiated regions of the ultraviolet irradiation.

Note that such an arrangement is adopted that the light-emitting diode 21 is evaluated in terms of illumination thereof by an illumination sensor 17 at each time of ultraviolet irradiation on the wafer. Owing to this, when it is detected that the illumination is lowered, the voltage is increased for each single diode or for each unit comprising plural light-emitting diodes, so that required illumination can be secured (in this case, the upper limit of the voltage has to be set). When illumination is detected to be insufficient despite that the voltage reaches the upper limit, each single diode or each unit comprising plural light-emitting diodes can be replaced, thereby stabilized performance of ultraviolet irradiation can be achieved regularly.

According to the preferred embodiment, there are no regions generated on the protection sheet S where the ultraviolet rays are not irradiated, so that the adhesive layer 18 can be completely cured throughout the regions, thus peeling of the protection sheet S in a subsequent process can be securely performed.

As described so far, the best arrangement and method to carry out the present invention are disclosed in the above description, but the present invention is not limited to this.

That is, the present invention is illustrated and explained particularly with regard to the specific preferred embodiment, but it is apparent to those skilled in the art that various modifications in shapes, positions, arrangements or the like of the described preferred embodiment can be made within the scope of the technical concept and the object of the present invention.

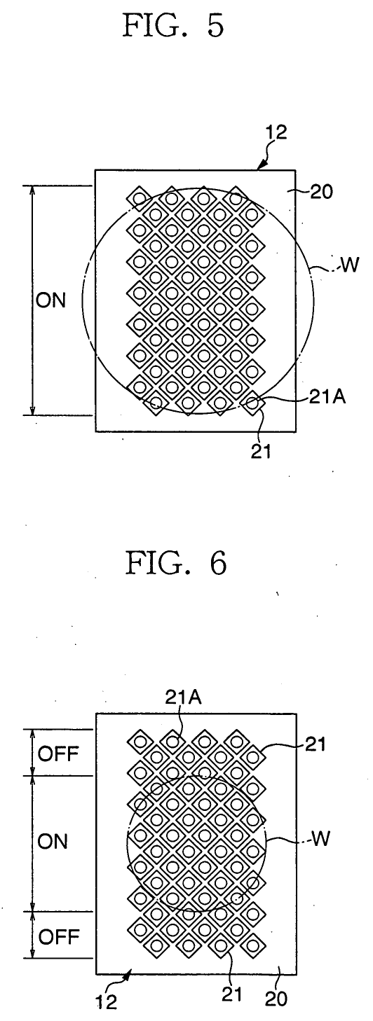

For example, as shown in FIG. 4, light-emitting timing of the light-emitting diodes 21 may be controlled individually in such a manner that the ultraviolet irradiation is sequentially performed in accordance with timing when the wafer W passes under the ultraviolet irradiation part 12. This control can be performed by inputting address data of each light-emitting diode 21 or each unit and the relative movement speed in advance to a controller (not shown). In an example in FIG. 4, the light-emitting diodes within the regions where the wafer W is overlapped right under the light-emitting diodes 21, are switched on, and groups of light-emitting diodes 21 or groups of units in the upper and lower sides are switched off. Accordingly, when the wafer W is advanced from a position in FIG. 4 to a position in FIG. 5, the light-emitting diodes in the whole regions are switched on, and as the wafer W is further advanced, off-regions are widened gradually.

As shown in FIG. 6, in case that a size of the wafer W is smaller compared with the region area disposed by the light-emitting diodes 21, it is possible to perform ultraviolet irradiation while keeping off the light-emitting diodes 21 in the regions not involved in irradiation substantially.

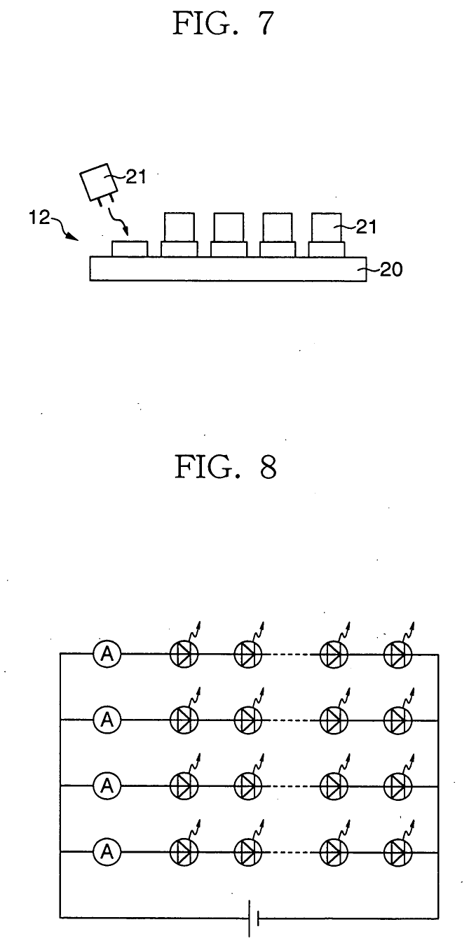

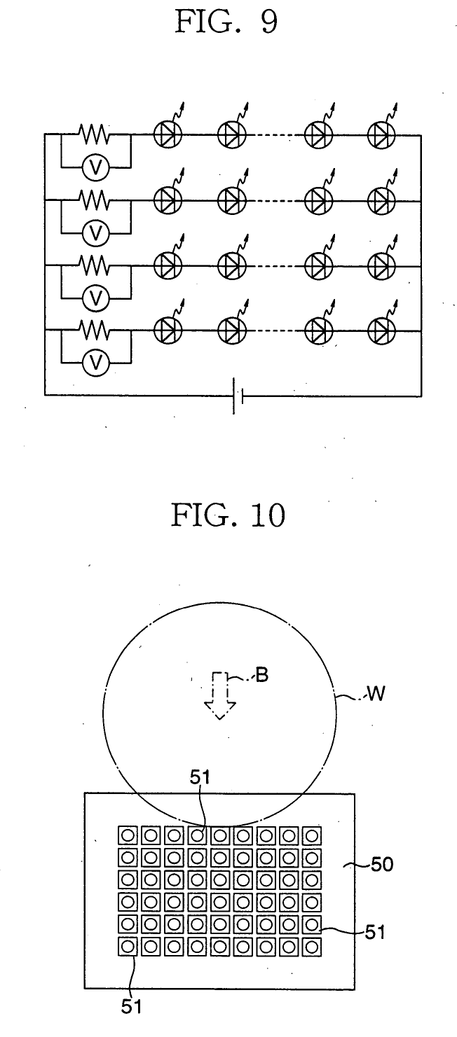

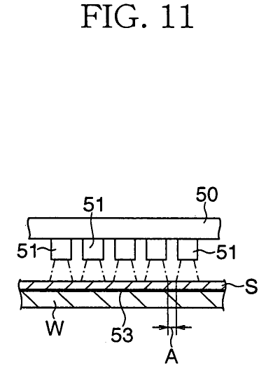

Further, as shown in FIG. 7, if the light-emitting diodes 21 are arranged to be fixed in detachable manner on the substrate 20, when a part of light-emitting diodes are failed for any reason, replacement work for the concerned part can be done in extremely easy way. Since it is not necessary to replace all the light-emitting diodes, maintenance costs can be minimized. The several light-emitting diodes may be arranged to form one unit to be replaced unit by unit. Detection of whether the light-emitting diodes 21 is in failure or not, as shown in FIGS. 8 and 9, can be made by measuring the value of current or voltage of each unit comprising a plurality of the light-emitting diodes. Herein the value of current or voltage may be measured for each single light-emitting diode in such a case that the number of the light-emitting diodes in an application is a few.

In the present invention, an object to be irradiated is not limited to a semiconductor wafer, but the present invention can be applied to anything that needs ultraviolet irradiation reaction without generating any regions not irradiated by ultraviolet.

1. An ultraviolet irradiation apparatus, comprising an arrangement of a plurality of ultraviolet light-emitting diodes to be disposed facing the object to be irradiated, the object and the light-emitting diodes being movable relatively with each other, wherein:
said light-emitting diodes are disposed with same intervals from each other on straight lines of a plurality of rows substantially perpendicular to the relative movement direction; and
the light-emitting diodes are arranged to be disposed so that between neighboring light-emitting diodes in each row, a part of the light-emitting diode of the neighboring row is positioned.

2. The ultraviolet irradiation apparatus according to claim 1, wherein: the light-emitting diodes are provided to be detachable on a substrate.

3. The ultraviolet irradiation apparatus according to claim 1, wherein: several light-emitting diodes are unitized as one unit; and
each unit comprising the several light-emitting diodes is provided to be detachable as a unit on a substrate.

4. The ultraviolet irradiation apparatus according to claim 1, wherein:
the light-emitting diodes are arranged in such a manner that light-emitting regions thereof are controllable in accordance with a flat area of the object.

5. The ultraviolet irradiation apparatus according to claim 1, wherein:
illumination sensors are disposed on a table supporting the object with a predetermined span along a direction substantially perpendicular to said relative movement direction.

6. The ultraviolet irradiation apparatus according to claim 1, wherein:
the several light-emitting diodes are unitized as one unit; and
irradiation performance of each unit or each single light-emitting diode is detected by value of current and/or voltage.
